(19) United States
(12) Patent Application Publication
(10) Pub. No.: US 2026/0163418 A1
(43) Pub. Date: Jun. 11, 2026

(54) MOTOR

(71) Applicants: AAC Microtech (Changzhou) Co., Ltd., Changzhou City (CN); Beijing Xiaomi Robot Technology Co., Ltd., Beijing (CN)

(72) Inventors: Sensen Yang, Changzhou (CN); Jinguo Wu, Changzhou (CN); Junsheng Wang, Changzhou (CN); Feng Yan, Changzhou (CN)

(21) Appl. No.: 19/178,833

(22) Filed: Apr. 14, 2025

Related U.S. Application Data
(63) Continuation of application No. PCT/CN2024/100172, filed on Jun. 19, 2024.

(51) Int. Cl. H02K 1/18; H02K 7/08; H02K 11/33; H02K 21/14

(52) U.S. Cl. CPC H02K 1/185; H02K 7/083; H02K 11/33; H02K 21/14; H02K 2211/03

(57) ABSTRACT

A motor is provided, including an outer housing, a stator, and a rotor. The outer housing includes an accommodating space, and the stator and the rotor are accommodated in the accommodating space, the rotor is rotatable with respect to the stator. The outer housing includes a first surface, the first surface is enclosed to form the accommodating space. The rotor includes a rotating shaft and a magnet, the rotating shaft is rotatable with respect to the outer housing, and the magnet is fixed to the rotating shaft. The stator includes a coil, the coil is disposed along a periphery of the magnet and is spaced apart with the magnet, the coil is fixed to the first surface through adhesive bonding. Therefore, magnetic flux leakage is effectively minimized, so that torque performance of the motor is higher and a structure of the motor is simpler.

### TECHNICAL FIELD

The present disclosure relates to the field of motors, and in particular to a motor being miniature and brushless, and having a hollow cup rotor.

### BACKGROUND

A working principle of brushless motors with hollow cup motors involves generating torque on charged conductors through interaction with electromagnetic fields. Specifically, when current passes through a stator coil, a rotating magnetic field is generated, a permanent magnet in a rotor is driven by the rotating magnetic field to generate rotating torque in a direction of the rotating magnetic field. The rotating toque drives the rotor to rotate, thereby enabling operation of a corresponding brushless motor.

However, motor products in the related art are prone to magnetic flux leakage, which affects torque performance thereof.

Therefore, it is necessary to provide a motor that effectively minimizes the magnetic flux leakage to enhance the torque performance thereof.

### SUMMARY

The present disclosure aims to provide a motor to solve a technical problem of magnetic flux leakage in the related art.

Technical solutions of the present disclosure are as following.

The present disclosure provides the motor, including an outer housing with an accommodating space, a stator, and a rotor. The stator and the rotor are accommodated in the accommodating space, the rotor is rotatable with respect to the stator. The outer housing includes a first surface enclosing the accommodating space. The rotor includes a rotating shaft and a magnet, the rotating shaft is rotatable with respect to the outer housing, and the magnet is fixed to the rotating shaft. The stator includes a coil, the coil is disposed along a periphery of the magnet and is spaced apart with the magnet, the coil is fixed to the first surface through adhesive bonding. A surface roughness of the first surface is ranged from 0.05 μm to 0.2 μm.

As an improvement, the first surface is treated by electrolytic polishing, a duration of electrolytic polishing treatment is ranged from 3 seconds to 5 seconds, and a current parameter of the electrolytic polishing treatment is ranged from 5.5 AS/dm to 55 AS/dm.

As an improvement, the coil is annular, the coil includes a second surface facing the first surface. The second surface and the first surface are fixed through the adhesive bonding.

As an improvement, the outer housing includes a housing body having openings at two ends thereof, a first cover body, and a second cover body, the housing body is hollow, and the first cover body and the second cover body respectively cover the two ends of the ends of the housing body. The housing body, the first cover body, and the second cover body together form the accommodating space. The first surface is disposed on the housing body.

As an improvement, a first end of the rotating shaft is fixed to the first cover body through a first bearing, a second end of the rotating shaft is fixed the second cover body through a second bearing. The rotating shaft is respectively rotatably connected to the first bearing and the second bearing.

As an improvement, a first gap is axially disposed between the coil and the first cover body, and a second gap is axially disposed between the coil and the second cover body.

As an improvement, the first cover body includes a first flange portion and at least one first positioning portion, both the first flange portion and the at least one first positioning portion protrude toward the housing body, and the at least one first positioning portion is disposed at an outer peripheral side of the first flange portion. The housing body includes a housing portion and a bending portion, the housing portion is cylindrical, and the bending portion is bent and extends from one end of the housing portion. A first mounting hole and at least one first positioning hole are disposed on the bending portion, the first flange portion is inserted into and matched with the first mounting hole, and the at least one first positioning portion is inserted into and matched with the second mounting hole.

As an improvement, the second cover body includes a second flange portion and at least one second positioning portion, the second flange portion protrudes toward the housing body, and the at least one second positioning portion protrudes from a peripheral surface of the second flange portion. The housing body includes a second mounting hole and at least one first positioning groove at one end thereof matching with the second cover body, the second flange portion is inserted into and matched with the second mounting hole, the at least one first positioning groove is disposed at an opening of the second mounting hole, and the at least one second positioning portion is inserted into and matched with the at least one first positioning groove.

As an improvement, the motor further includes a circuit board, the circuit board is electrically connected to the coil, and the circuit board is fixed to the second cover body.

As an improvement, the circuit board is disposed outside the accommodating space, the second cover body includes at least one third positioning portion at one end thereof away from the housing body, and the circuit board includes at least second positioning groove, the at least one third positioning portion is inserted into and matched with the at least one second positioning groove.

Beneficial effects of the present disclosure are as following.

In the motor of the present disclosure, the coil is directly fixed to the first surface of the housing body through the adhesive bonding without providing an insulating layer or an insulating tape structure between the coil and the housing body, which is beneficial for miniaturization of the motor to simplify a structure of the motor and also effectively reducing the magnetic flux leakage to enable higher torque performance of the motor. Moreover, when the motor has the same dimension, a thickness of the coil is increased, thereby improving magnetic field performance and enabling the higher torque performance of the motor. Meanwhile, the surface roughness of the first surface is ranged from 0.05 μm to 0.2 μm, which prevents the coil from being scratched by the first surface when being fixed to the first surface through the adhesive bonding, thereby effectively improves a product yield.

### BRIEF DESCRIPTION OF DRAWINGS

FIG. 1 is a structural schematic diagram of a motor of the present disclosure.

FIG. 2 is another structural schematic diagram of the motor shown in FIG. 1.

FIG. 3 is another structural schematic diagram of the motor shown in FIG. 1

FIG. 4 is a cross-sectional schematic diagram taken along the line A-A of FIG. 1.

FIG. 5 is a right side schematic diagram of FIG. 3.

FIG. 6 is a cross-sectional schematic diagram taken along the line B-B of FIG. 5.

FIG. 7 is a cross-sectional schematic diagram taken along the line C-C of FIG. 5.

FIG. 8 is an exploded schematic diagram of the motor shown in FIG. 1.

FIG. 9 is a structural enlarged schematic diagram of a second cover body of the motor shown in FIG. 8.

FIG. 10 is another exploded schematic diagram of the motor shown in FIG. 1.

FIG. 11 is a structural enlarged schematic diagram of a first cover body of the motor shown in FIG. 10.

FIG. 12 is a structural enlarged schematic diagram of the second cover body of the motor shown in FIG. 10.

### DETAILED DESCRIPTION OF EMBODIMENTS

The present disclosure is further described below with reference to accompanying drawings and embodiments.

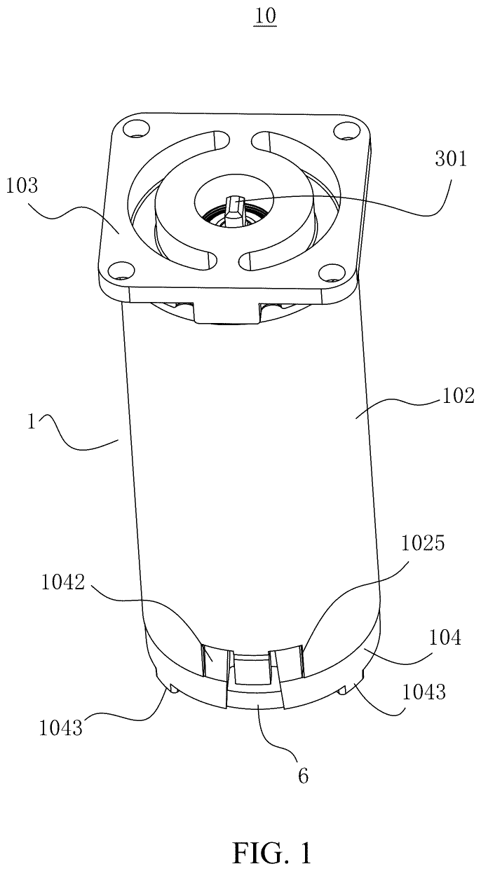

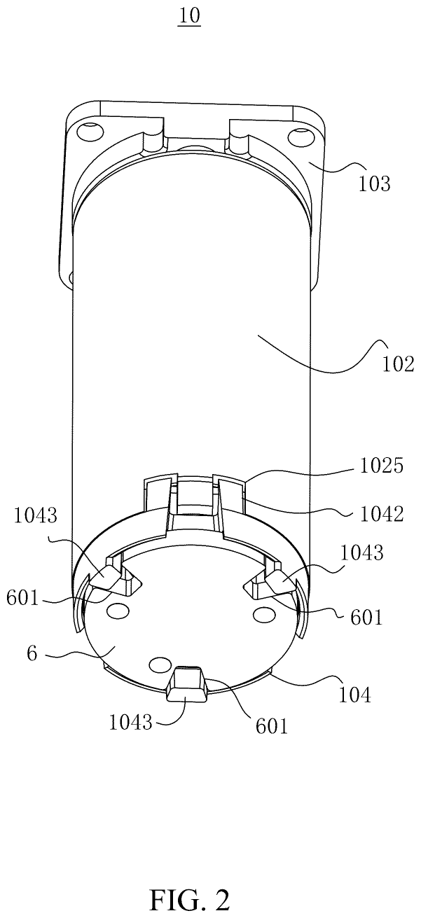

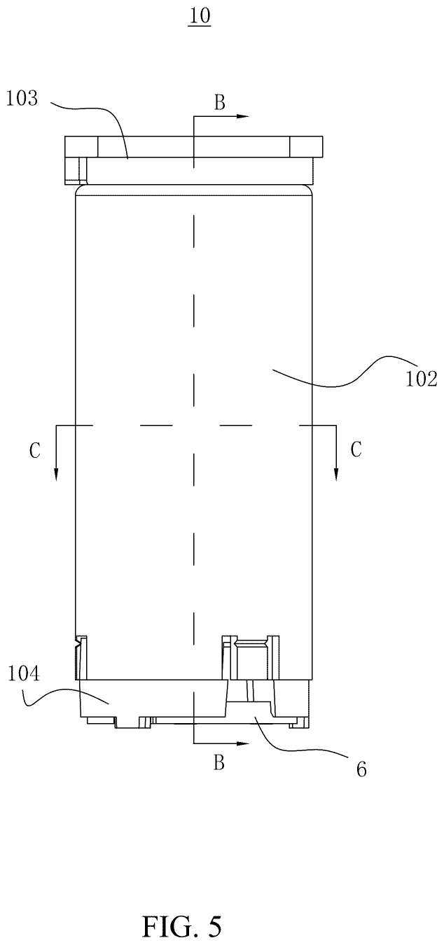

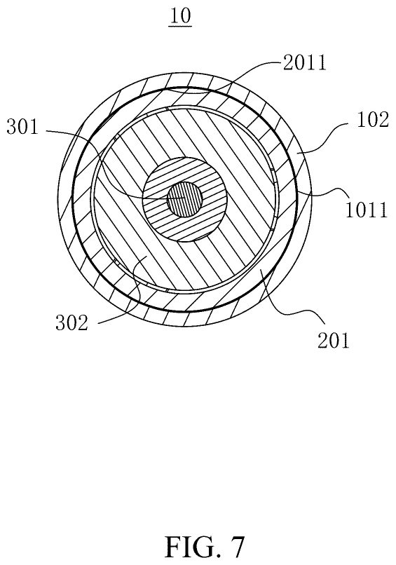

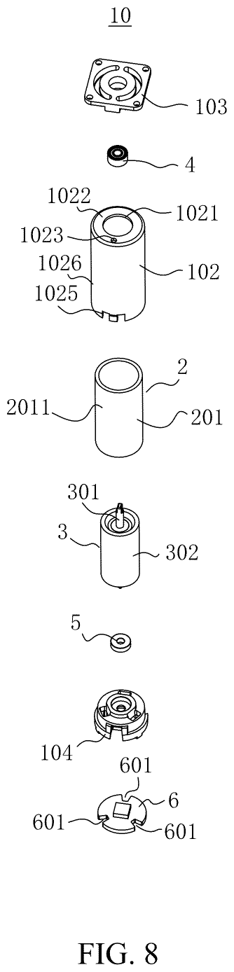

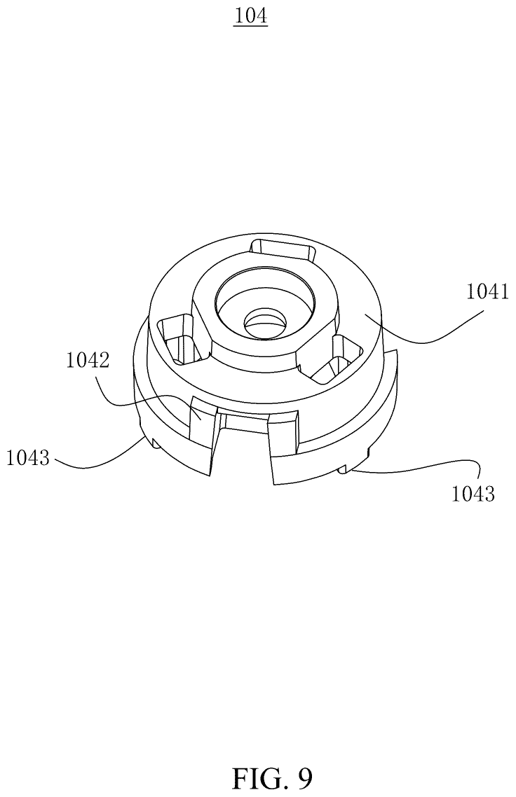

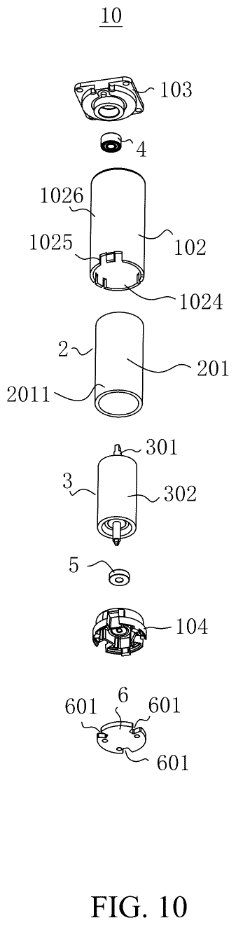

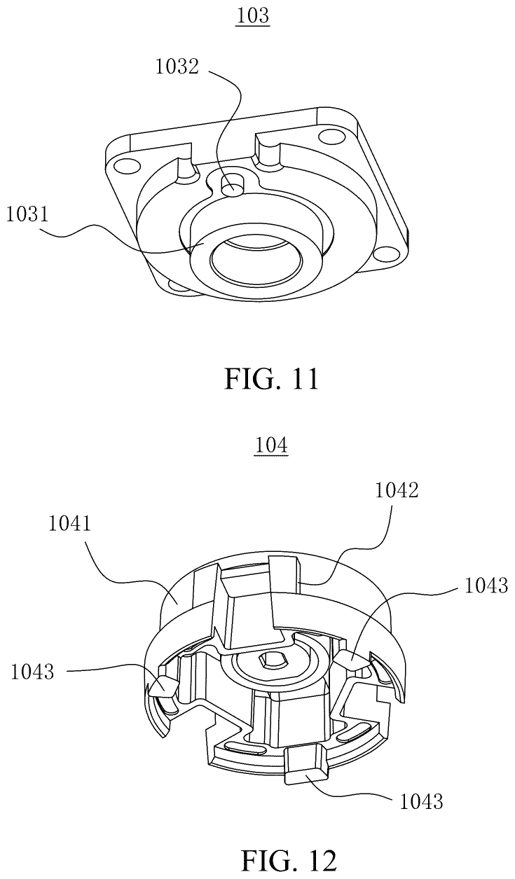

Please refer to FIGS. 1-12, the embodiments of the present disclosure provide a motor 10, as shown in FIGS. 1-4, including an outer housing 1 with an accommodating space 101, a stator 2, and a rotor 3, the stator 2 and the rotor 3 are accommodated in the accommodating space 101, the rotor 3 is rotatable with respect to the stator 2.

Specifically, the outer housing 1 includes a housing body 102 having openings at two ends thereof, a first cover body 103, and a second cover body 104, the housing body 102 is hollow. The first cover body 103 is fixed to and covers a first end of the housing body 102, and the second cover body 104 is fixed to and covers a second end of the housing body 102. The housing body 102, the first cover body 103, and the second cover body 104 together form the accommodating space 101.

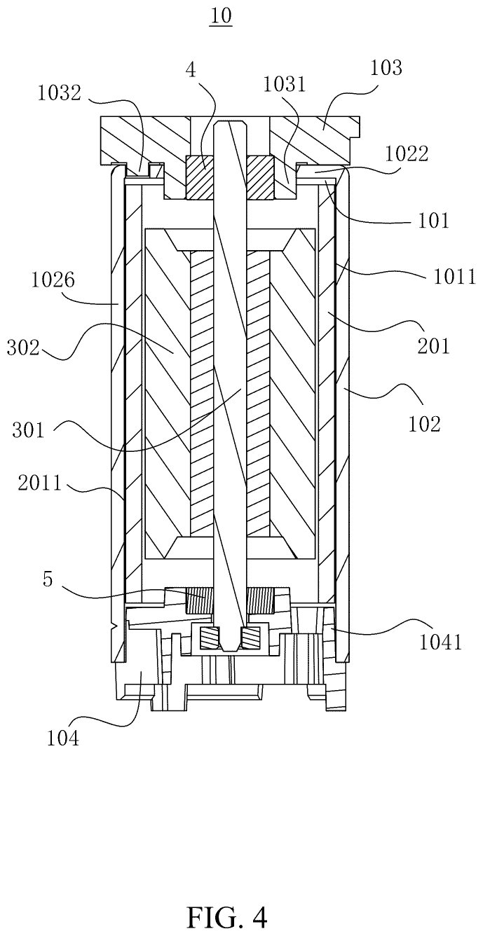

Please refer to FIGS. 4, 6, 8, and 10, the rotor 3 includes a rotating shaft 301 and a magnet 302, the rotating shaft 301 is rotatable with respect to the outer housing 1, and the magnet 302 is fixed to the rotating shaft 301. The motor 10 further includes a first bearing 4 and a second bearing 5, a first end of the rotating shaft 301 is fixed to the outer housing 1 through the first bearing 4, a second end of the rotating shaft 301 is fixed the outer housing 1 through the second bearing 5. In the embodiments, the first bearing 4 is disposed on the first cover body 103, the second bearing 5 is disposed on the second cover body 104. A first end of the rotating shaft 301 is fixed to the first cover body 103 through a first bearing 4, a second end of the rotating shaft 301 is fixed to the second cover body 104 through a second bearing 5. Both the first bearing 4 and the second bearing 5 are rotating bearings, and the first bearing 4 and the second bearing 5 jointly support the rotating shaft 301, thereby reducing friction of the rotating shaft 301 during rotation.

The housing body 102 includes a first surface 1011, the first surface 1011 encloses the accommodating space 101. The stator 2 includes a coil 201, the coil 201 is disposed along a periphery of the magnet 302 and is spaced apart with the magnet 302, the coil 201 is fixed to the first surface 1011 through adhesive bonding. A surface roughness of the first surface 1011 is ranged from 0.05 μm to 0.2 μm.

In the embodiments of the present disclosure, please refer to FIGS. 4, 6, and 7, the coil 201 is directly fixed to the first surface 1011 through the adhesive bonding without providing an insulating layer or an insulating tape structure between the coil 201 and the housing body 102, which is beneficial for miniaturization of the motor 10 to simplify a structure of the motor 10 and also effectively reducing magnetic flux leakage to enable higher torque performance of the motor 10. Moreover, when the motor 10 has the same dimension, a thickness of the coil 201 is increased, thereby improving magnetic field performance and enabling the higher torque performance of the motor 10. Meanwhile, the surface roughness of the first surface 1011 is ranged from 0.05 μm to 0.2 μm, which prevents the coil 201 from being scratched by the first surface 1011 when being fixed to the first surface 1011 through the adhesive bonding, thereby effectively improves a product yield.

In the embodiments of the present disclosure, the first surface 1011 is treated by electrolytic polishing, a duration of electrolytic polishing treatment is ranged from 3 seconds to 5 seconds, and a current parameter of the electrolytic polishing treatment is ranged from 5.5 AS/dm to 55 AS/dm, in this way, the surface roughness of the first surface 1011 reaches 0.05-0.2 μm. It may be understood that, in other embodiments, other solutions may also be adopted to polish the outer housing 1, as long as the coil 201 is not scratched by an inner wall of the housing body 102.

Please refer to FIGS. 4, 6, and 7, the coil 201 is annular, the coil 201 includes a second surface 2011 facing the first surface 1011. The second surface 2011 and the first surface 1011 are fixed through the adhesive bonding.

Please refer to FIGS. 4, 6, and 7, the first surface 1011 may be cylindrical, the second surface 2011 may also be cylindrical, and the second surface 2011 and the first surface 1011 are fixed through the adhesive bonding, in this way, the magnetic flux leakage is reduced as much as possible, thereby enabling the higher torque performance of the motor 10.

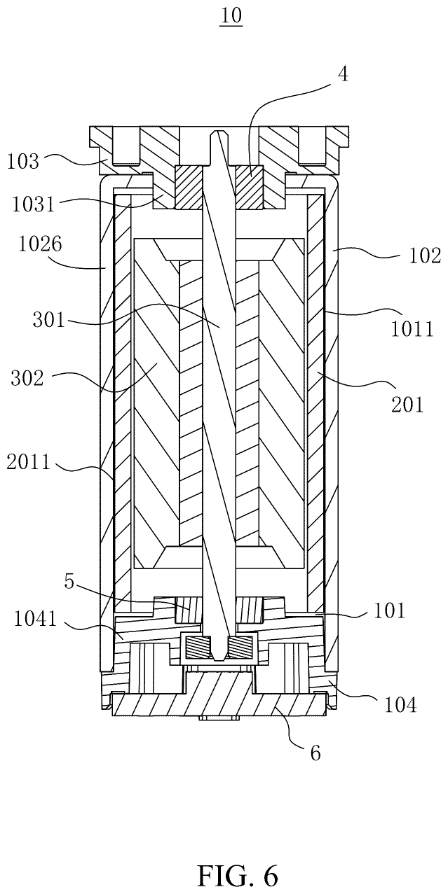

Please refer to FIGS. 4 and 6, a first gap is axially disposed between the coil 201 and the first cover body 103, and a second gap is axially disposed between the coil 201 and the second cover body 104, which prevents the coil 201 from being pressed by the first cover body 103 and the second cover body 104 when assembly, thereby avoiding deformation of the coil 201.

Please refer to FIGS. 4, 6, 8, and 11, the housing body 102 includes a housing portion 1026 and a bending portion 1022, the housing portion 1022 is cylindrical, and the bending portion 1022 is bent and extends from one end of the housing portion 1026. A first mounting hole 1021 is disposed on the bending portion 1022, the first cover body 103 comprises a first flange portion 1031. The first flange portion 1031 protrudes toward the housing body 102, and the first flange portion 1031 is inserted into and matched with the first mounting hole 1021. In this way, assembly between the first cover body 103 and the housing body 102 is more accurate, and the first cover body 103 and the housing body 102 are more conveniently and accurately mounted.

Please refer to FIGS. 4, 8, and 11, the first cover body 103 further includes at least one first positioning portion 1032, the at least one first positioning portion 1032 protrudes toward the housing body 102, at least one first positioning hole 1023 is disposed on the bending portion 1022, the at least one first positioning portion 1032 is inserted into and matched with the at least one first positioning hole 1023, so that not only is the assembly between the first cover body 103 and the housing body 102 more accurate, but also an anti-rotation effect is achieved, the first cover body 103 is prevented from rotating with respect to the housing body 102, assembly precision is further improved, and the structure of the motor 10 is more stable.

In some embodiments, please refer to FIGS. 4, 8, and 11, one first positioning portion 1032 is provided, and correspondingly, one first positioning hole 1023 is provided. In other embodiments, a plurality of first positioning portions 1032 are provided, and correspondingly, a plurality of first positioning holes 1023 are provided, and the plurality of the first positioning portions 1032 are respectively inserted into and matched with the plurality of the first positioning holes 1023, so that the assembly precision and the anti-rotation effect are further improved, specific arrangements are chosen based on actual conditions. For example, all of the plurality of the first positioning portions 1032 are evenly distributed at intervals in a circumferential direction of the first flange portion 1031 or are distributed in other forms, and details are not described herein.

It may be understood that, in other embodiments, the at least one first positioning portion 1032 is of another structure, as long as the at least one first positioning portion 1032 cooperates with the housing body 102, the assembly between the first cover body 103 and the housing body 102 is more accurate, so that the first cover body 103 is prevented from rotating with respect to the housing body 102, and details are not described herein.

Please refer to FIGS. 4, 6, 9, 10, and 12, the housing body 102 includes a second mounting hole 1024 at one end thereof matching with the second cover body 104. The second cover body 104 comprises a second flange portion 1041, the second flange portion 1041 protrudes toward the housing body 102, the second flange portion 1041 is inserted into and matched with the second mounting hole 1024, so that assembly between the second cover body 104 and the housing body 102 is more accurate, and the second cover body 104 and the housing body 102 are more conveniently and accurately mounted.

Specifically, the coil is mounted to the first surface 1011 of the housing body 102 through the first mounting hole 1021 or the second mounting hole 1024.

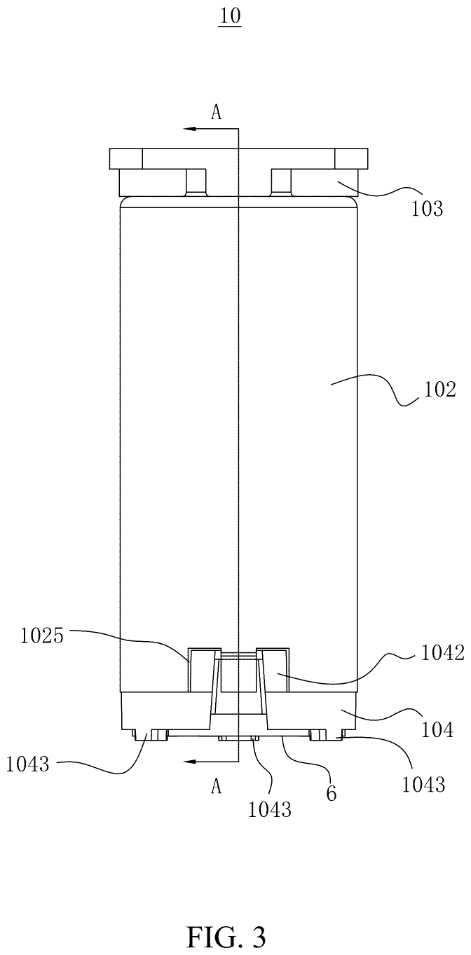

Please refer to FIGS. 3, 9, and 12, the second cover body 104 further includes at least one second positioning portion 1042, the at least one second positioning portion 1042 protrudes toward the housing body 102, and the at least one second positioning portion 1042 is inserted into and matched with the housing body 102, so that not only is the assembly between the second cover body 104 and the housing body 102 more accurate, but also an anti-rotation effect is achieved, the second cover body 104 is prevented from rotating with respect to the housing body 102, assembly precision is further improved, and the structure of the motor 10 is more stable.

Specifically, the at least one second positioning portion 1042 protrudes from a peripheral surface of the second flange portion 1041, the housing body 102 further includes at least one first positioning groove 1025 at one end thereof matching with the second cover body 104, the at least one first positioning groove 1025 is disposed at an opening of the second mounting hole 1024.

One second positioning portion 1042 is provided, and correspondingly, one first positioning groove 1025 is provided. In other embodiments, a plurality of second positioning portions 1042 are provided, and correspondingly, a plurality of first positioning grooves 1025 are provided. The number of the plurality of the first positioning grooves 1025 is equal to the number of the plurality of the second positioning portions 1042, and the plurality of the second positioning portions 1042 are respectively inserted into and matched with the plurality of first positioning grooves 1025. All of the plurality of the second positioning portions 1042 are evenly distributed at intervals in a circumferential direction of the second flange portion 1041 or are distributed in other forms, and details are not described herein.

Please refer to FIGS. 1-3, 5, 6, 8, and 10, the motor 10 further includes a circuit board 6, the circuit board 6 is electrically connected to the coil 201, thereby supplying power to the coil 201. The circuit board 6 is fixed to the second cover body 1, thereby enabling more stable electrical connection between the circuit board 6 and the coil 201. In the embodiments, the circuit board 6 is fixed to the second cover body 104.

Please refer to FIG. 6, the circuit board 6 is disposed outside the accommodating space 101. Please refer to FIGS. 1-3, 8-10, and 12, the second cover body 104 includes at least one third positioning portion 1043 at one end thereof away from the housing body 102, the at least one third positioning portion 1043 protrudes toward the circuit board 6, and the circuit board 6 includes at least second positioning groove 601, the at least one third positioning portion 1043 is inserted into and matched with the at least one second positioning groove 601, so that not only is assembly between the second cover body 104 and the circuit board 6 more accurate, but also an anti-rotation effect is achieved, the second cover body 104 is prevented from rotating with respect to the circuit board 6, assembly precision is further improved, and the structure of the motor 10 is more stable. It should be noted that one, two, or even more third positioning portions 1043 are provided, and details are not described herein, as long as the at least one second positioning groove 601 and the at least one third positioning portion 1043 are in one-to-one correspondence, so that the second cover body 104 and the circuit board 6 are accurately assembled, thereby preventing the second cover body 104 and the circuit board 6 from rotating relative to each other.

The foregoing are merely embodiments of the present disclosure, and it should be noted that, for those who skilled in the art, improvements can be made without departing from concepts of the present disclosure, but these are all within protection scopes of the present disclosure.

What is claimed is:

1. A motor, comprising:
an outer housing with an accommodating space, comprising a first surface enclosing the accommodating space;
a stator accommodated in the accommodating space, and comprising a coil; and
a rotor rotatable with respect to the stator, comprising:
a rotating shaft rotatable with respect to the outer housing; and
a magnet fixed to the rotating shaft;
wherein the coil is disposed along a periphery of the magnet and is spaced apart with the magnet, the coil is fixed to the first surface through adhesive bonding; and
a surface roughness of the first surface is ranged from 0.05 μm to 0.2 μm.

2. The motor according to claim 1, wherein the first surface is treated by electrolytic polishing, a duration of electrolytic polishing treatment is ranged from 3 seconds to 5 seconds, and a current parameter of the electrolytic polishing treatment is ranged from 5.5 AS/dm to 55 AS/dm.

3. The motor according to claim 1, wherein the coil is annular, the coil comprises a second surface facing the first surface; and
the second surface and the first surface are fixed through the adhesive bonding.

4. The motor according to claim 1, wherein the outer housing comprises a housing body having openings at two ends thereof, a first cover body, and a second cover body, the housing body is hollow, and the first cover body and the second cover body respectively cover the two ends of the ends of the housing body;
the housing body, the first cover body, and the second cover body together form the accommodating space; and
the first surface is disposed on the housing body.

5. The motor according to claim 4, wherein a first end of the rotating shaft is fixed to the first cover body through a first bearing, a second end of the rotating shaft is fixed to the second cover body through a second bearing; and
the rotating shaft is respectively rotatably connected to the first bearing and the second bearing.

6. The motor according to claim 4, wherein a first gap is axially disposed between the coil and the first cover body, and a second gap is axially disposed between the coil and the second cover body.

7. The motor according to claim 4, wherein the first cover body comprises a first flange portion and at least one first positioning portion, both the first flange portion and the at least one first positioning portion protrude toward the housing body, and the at least one first positioning portion is disposed at an outer peripheral side of the first flange portion;
the housing body comprises a housing portion and a bending portion, the housing portion is cylindrical, and the bending portion is bent and extends from one end of the housing portion; and
a first mounting hole and at least one first positioning hole are disposed on the bending portion, the first flange portion is inserted into and matched with the first mounting hole, and the at least one first positioning portion is inserted into and matched with the second mounting hole.

8. The motor according to claim 4, wherein the second cover body comprises a second flange portion and at least one second positioning portion, the second flange portion protrudes toward the housing body, and the at least one second positioning portion protrudes from a peripheral surface of the second flange portion;
the housing body includes a second mounting hole and at least one first positioning groove at one end thereof matching with the second cover body, the second flange portion is inserted into and matched with the second mounting hole, the at least one first positioning groove is disposed at an opening of the second mounting hole, and the at least one second positioning portion is inserted into and matched with the at least one first positioning groove.

9. The motor according to claim 4, wherein the motor further comprises a circuit board, the circuit board is electrically connected to the coil, and the circuit board is fixed to the second cover body.

10. The motor according to claim 9, wherein the circuit board is disposed outside the accommodating space, the second cover body comprises at least one third positioning portion at one end thereof away from the housing body, and the circuit board includes at least second positioning groove, the at least one third positioning portion is inserted into and matched with the at least one second positioning groove.
